(19) United States
(12) Patent Application Publication
(10) Pub. No.: US 2025/0327914 A1
(43) Pub. Date: Oct. 23, 2025

(54) LIGHT DETECTION AND RANGING (LIDAR) SYSTEM CALIBRATION

(71) Applicant: GM Global Technology Operations LLC, Detroit, MI (US)

(72) Inventors: Yousef Adnan Omar, Troy, MI (US); Yao Hu, Sterling Heights, MI (US); Xinyu Du, Oakland Township, MI (US); Hao Yu, Troy, MI (US)

(21) Appl. No.: 18/641,527

(22) Filed: Apr. 22, 2024

(51) Int. Cl. G01S 7/497

(52) U.S. Cl. CPC G01S 7/4972

(57) ABSTRACT

A process for calibrating a LiDAR system includes physically aligning a body on a calibration structure, wherein a LiDAR system is mounted on the body and centering the body using the calibration structure. A LiDAR point cloud is generated using the LiDAR system. A first linear structure and a ground plane is detected using the LiDAR point cloud and a first vector aligned with the first linear structure is determined. A first plane normal to the first vector is identified, and a second vector normal to the ground plane and in the first plane is identified. A second plane normal to the second vector is identified. A third vector at an intersection of the first plane and the second plane is identified. A third plane normal to the third vector is identified, and an orientation of the LiDAR system relative to the body using the planes and vectors is calibrated.

### INTRODUCTION

The subject disclosure relates to LiDAR (light detection and ranging) systems for vehicles, and more particularly to a system and method for calibrating a relative orientation of a LiDAR system and a vehicle body to which the LiDAR system is mounted.

Modern vehicles include increasingly advanced detection systems for providing environmental awareness and object detection. LiDAR is one such detection system and operates by targeting an object or a surface with a laser and measuring a time for reflected light to return to the receiver.

In the example of vehicle ranging systems, and similar systems, a LiDAR ranger can emit light across a wide area, measure the time for reflections to return, and thereby generate a cloud of data points. The cloud of data points is referred to as a point cloud. Each data point in the point cloud includes a distance from the data point to the LiDAR sensor and an angular direction of the data point from the LiDAR sensor. Using the combination of distance and angular direction, the point cloud provides a three dimensional topology of the surrounding environment.

The three dimensional topology can then be used in conjunction with other vehicle sensors and imaging devices to develop a knowledge of the extrinsic elements in the environment in which the vehicle is operating. This knowledge is utilized to aid in automated or semi-automated vehicle operations, vehicle warning systems, and any similar devices or systems.

The generated three dimensional topology is defined with regards to the absolute position of the LiDAR system. As such, it is desirable to ensure that a relative orientation of the LiDAR system and the body to which the LiDAR system is mounted (e.g. a vehicle body) is known as accurately as possible in order to provide the most accurate positional information of the extrinsic elements relative to the vehicle body.

### SUMMARY

In one exemplary embodiment a process for calibrating a LiDAR (light detection and ranging) system includes physically aligning a body on a calibration structure, wherein a LiDAR system is mounted on the body and centering the body using the calibration structure. A LiDAR point cloud is generated using the LiDAR system. A first linear structure and a ground plane is detected using the LiDAR point cloud and a first vector aligned with the first linear structure is determined. A first plane normal to the first vector is identified, and a second vector normal to the ground plane and in the first plane is identified. A second plane normal to the second vector is identified. A third vector at an intersection of the first plane and the second plane is identified. A third plane normal to the third vector is identified, and an orientation of the LiDAR system relative to the body using the first plane, the second plane, the third plane, the first vector, the second vector, and the third vector is calibrated.

In addition to one or more of the features described herein the first linear structure is a line disposed on the ground plane and extending from a front edge of the calibration structure.

In addition to one or more of the features described herein the first linear structure is a first line disposed in the ground plane within a range of the LiDAR system and wherein the line is approximately parallel to a front edge of the calibration structure.

In addition to one or more of the features described herein the first linear structure further comprises a second line disposed in the ground plane and extending perpendicular from the first line to a front edge of the calibration structure, and wherein the first vector is aligned with the second line.

In addition to one or more of the features described herein the first linear structure is a planar surface normal to the ground plane and wherein the first vector is normal to the planar structure, the second vector is normal to the ground plane, and the third vector is a cross product of the first vector and the second vector.

In addition to one or more of the features described herein the first linear structure is a linear bar suspended above, and parallel to, the ground plane.

In addition to one or more of the features described herein the first linear structure is contrasted with a surrounding environment.

In addition to one or more of the features described herein at least a portion of the first linear structure is one of a retroreflective paint and a retroreflective coating.

In addition to one or more of the features described herein the body is a vehicle body and wherein the process is performed using a vehicle controller within the vehicle body.

In addition to one or more of the features described herein centering the body using the calibration structure comprises physically moving the body using the calibration structure.

In another exemplary embodiment a LiDAR (light detection and ranging) calibration system includes a body positioning system configured to identify an orientation of a body. A first linear structure is disposed in a known position relative to the body positioning system. A controller is configured to identify a relative position and orientation of a LiDAR system mounted to a body within the body positioning system, relative to the body, by generating a LiDAR point cloud using the LiDAR system, detecting a first linear structure and a ground plane using the LiDAR point cloud and determining a first vector aligned with the first linear structure, identifying a first plane normal to the first vector, identifying a second vector normal to the ground plane and in the first plane, and identifying a second plane normal to the second vector, identifying a third vector at an intersection of the first plane and the second plane, identifying a third plane normal to the third vector, and calibrating an orientation of the LiDAR system relative to the body using the first plane, the second plane, the third plane, the first vector, the second vector, and the third vector.

In addition to one or more of the features described herein the first linear structure is a line disposed on the ground plane and extending from an edge of the body positioning system.

In addition to one or more of the features described herein the first linear structure is a first line disposed in the ground plane within a range of the LiDAR system and wherein the line is approximately parallel to a front edge of the body positioning system.

In addition to one or more of the features described herein the first linear structure further comprises a second line disposed in the ground plane and extending perpendicular from the first line to a front edge of the body positioning system, and wherein the first vector is aligned with the second line.

In addition to one or more of the features described herein the first linear structure is a planar surface normal to the ground plane and wherein the second vector is an edge of the planar surface and the third vector is a second edge of the planar surface.

In addition to one or more of the features described herein the first linear structure is a linear bar suspended above, and parallel to, the ground plane.

In addition to one or more of the features described herein the first linear structure is contrasted with a surrounding environment.

In addition to one or more of the features described herein at least a portion of the first linear structure is one of a retroreflective paint and a retroreflective coating.

In addition to one or more of the features described herein the body is a vehicle body.

In another exemplary embodiment a vehicle includes a LiDAR (light detection and ranging) system, and a vehicle controller in communication with the LiDAR system. The vehicle controller includes a memory storing instructions to cause the controller to generate a LiDAR point cloud using the LiDAR system, detect a first linear structure and a ground plane using the LiDAR point cloud and determine a first vector aligned with the first linear structure, identify a first plane normal to the first vector, identify a second vector normal to the ground plane and in the first plane, and identify a second plane normal to the second vector, identify a third vector at an intersection of the first plane and the second plane, identify a third plane normal to the third vector, and calibrate an orientation of the LiDAR system relative to the body using the first plane, the second plane, the third plane, the first vector, the second vector, and the third vector.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a LiDAR ranging system;

FIG. 2 depicts a process for calibrating a relative position of a LiDAR ranging system and a vehicle body using a first calibration structure;

FIG. 3 depicts a second calibration structure for generating calibration planes according to one example;

FIG. 4 depicts a third calibration structure for generating calibration planes according to another example;

FIG. 5 depicts a fourth calibration structure for generating calibration planes according to another example; and

FIG. 6 depicts a fifth calibration structure for generating calibration planes according to another example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment methods, devices and systems are provided for calibrating a relative position and orientation of a LiDAR (light detection and ranging) sensor system and a vehicle body by using at least one physical line having a known position and orientation relative to the vehicle body to determine a set of imaginary planes. Once determined, the set of imaginary planes is used to determine a relative orientation of the LiDAR system and the vehicle body, thereby ensuring accurate detection of extrinsic environmental factors.

Embodiments described herein present numerous advantages and technical effects including an increased speed of the calibration process, and a decreased likelihood of errors occurring within the calibration process.

The embodiments are not limited to use with any specific vehicle and may be applicable to various contexts. For example, the LiDAR orientation calibration can be applied to any machine including a LiDAR sensor mounted to a primary body where the body position and orientation is known to a high degree, and where at least one calibration line (or similar structure) can be included in a fixed position relative to the primary body. By way of example, the LiDAR orientation calibration could be applied to an articulation arm in a manufacturing environment or a calibration station at the end of a manufacturing line for any similar body in addition to calibrating a LiDAR system for a vehicle. The enumerated uses of the calibration system and process are exemplary in nature and are non-limiting.

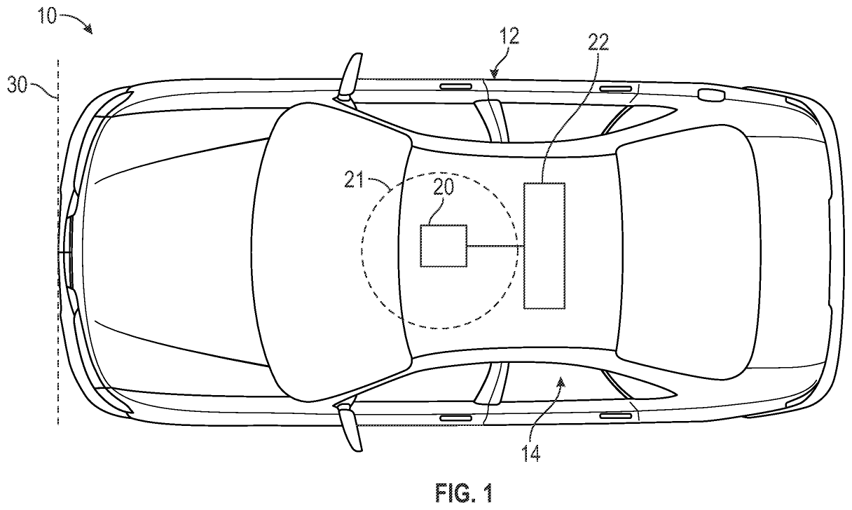

FIG. 1 shows an embodiment of a motor vehicle 10, which includes a vehicle body 12 defining, at least in part, an occupant compartment 14. The vehicle body 12 also supports various vehicle subsystems (not shown) including a propulsion system, and other subsystems to support functions of the propulsion system and other vehicle 10 components, such as a braking subsystem, a suspension system, a steering subsystem, a fuel injection subsystem, an exhaust subsystem and others.

Also included on the vehicle body 12 is a LiDAR system 20 configured to detect a point cloud 21 in an area surrounding the LiDAR system 20. While illustrated as a small circle surrounding the LiDAR system 20, it is appreciated that in practice the point cloud 21 will extend substantially beyond the vehicle body 12, such that the point cloud 21 encompasses a surrounding environment. Furthermore, it is appreciated that the positioning of the LiDAR system 20 and a controller 22 within a practical implementation of the vehicle 10 may differ from the illustrated positions without altering the systems and operations described herein.

The LiDAR system 20 is communicatively coupled to a controller 22. The controller 22 is configured to interpret the point cloud 21 identified by the LiDAR system 20 and to utilize the interpretation to determine extrinsic information about the environment through which the vehicle 10 is traveling or in which the vehicle 10 is positioned. The controller 22 typically includes at least a memory and a processor and can be a dedicated LiDAR controller, a general vehicle controller, a vision systems controller, and/or any other controller or combination of controllers able to interpret or utilize the point cloud 21.

The vehicle 10 may be an electrically powered vehicle (EV) or a hybrid vehicle. In an embodiment the vehicle 10 is an electric vehicle including at least one electric motor assembly (not shown). In alternative examples, the vehicle 10 may be any other type of vehicle incorporating a LiDAR sensor system 20.

When using a LiDAR system 20 to determine a relative location of extrinsic elements, it is important to know the angular and rotational position of the LiDAR system 20 relative to the vehicle body 12. If the LiDAR system 20 is misaligned by (for example) one degree, a rotational shift of each point in the point cloud 21 relative to the vehicle body 12 results. This, in turn, can disrupt systems such as automated driving and/or driver assist systems that rely on the extrinsic information of the point cloud 21, by rotationally skewing the perceived location of the points in the point cloud 21.

In order to ensure optimal operation of the LiDAR system 20, the LiDAR system 20 is calibrated relative to the vehicle body 12 after manufacturing, and before the vehicle 10 is placed in operation. Typical calibration techniques include placing the vehicle 10 in a known position and detecting multiple planar panels disposed about the vehicle 10 in known positions and orientations relative to the position of the vehicle body 12. These calibration techniques are subject to disruption and/or error as an operator must verify each panel position at each calibration in order to ensure that the locations and/or orientations of the panels has not been shifted (e.g. due to incidental bumping, environmental conditions such as wind, or any other cause). This methodology requires a relatively substantial amount of time to perform each calibration. Furthermore, the existing calibration techniques include high degrees of complexity and are prone to errors resulting from noisy LiDAR data.

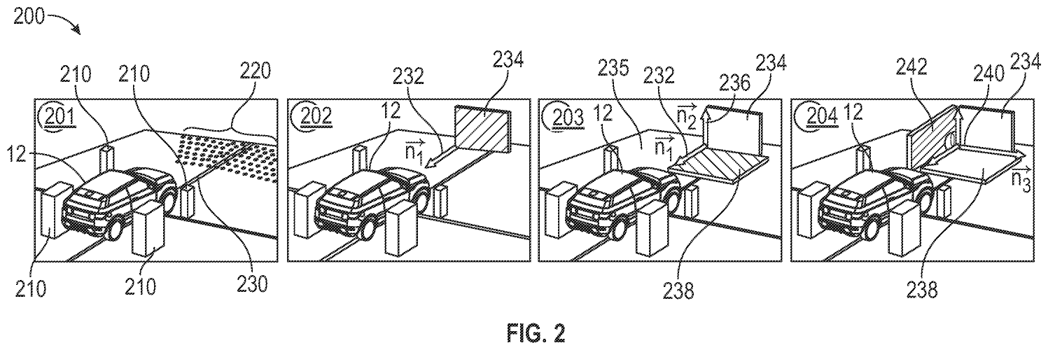

With continued reference to FIG. 1, FIG. 2 illustrates an example process 200 and system for quickly and efficiently calibrating an orientation of a LiDAR system 20 relative to a vehicle body 12 on which the LiDAR system 20 is mounted, using only a single fixed environmental feature to generate a set of calibration planes 234, 238, 242.

Initially, after manufacturing of the vehicle 10 is completed, the vehicle 10 is moved to a calibration position, and calibration blocks 210 determine an exact position and orientation of the vehicle body 12 to an error margin of approximately 3-5 mm. The calibration blocks 210 represent any known position calibration system able to mechanically center the vehicle body 12 to the described degree of accuracy.

After establishing the position of the vehicle body 12, the LiDAR system 20 (illustrated in FIG. 1, hidden in FIG. 2) detects a point cloud 220 of the extrinsic environment in a first step 201. Included within the point cloud 220 are detections of a line 230. The line 230 is drawn outward from the calibration blocks 210 at a precisely known angle and position, relative to the calibration blocks 210. Due to this positioning, and the precise knowledge of the location of the vehicle 10 relative to the calibration blocks 210, a precise angle of the line 230 relative to the vehicle 10 can be known.

In some examples, the line 230 is a line of retroreflective paint, tape, or other material disposed on the ground or other surface in a known position and orientation. In other examples, the line 230 can be a raised curb, an edge or any other detectable physical structure forming the line 230. Retroreflective materials are used to draw the line 230 in some examples as such materials have a substantially increased reflectiveness allowing for the LiDAR system 20 to easily and quickly distinguish the line 230 from any other extrinsic elements detected within the point cloud 220. In some further examples, this effect can be enhanced by utilizing materials and/or coatings having a high amount of light absorption for the areas and features surrounding the line 230, thereby increasing the contrast between the data point in the point cloud 220 reflected by the line 230 and the data points in the point cloud 220 reflected by the surrounding elements.

Once the line 230 has been established, the controller 22 defines a vector 232 (n1) along the line 230 and constructs a first plane 234 normal to the vector 232 in a second step 202.

The controller 22 then detects a ground plane 235 and constructs a second vector 236 (n2) within the first plane 234 and normal to the ground plane 235 in a step 203. A second plane 238 is constructed normal to the second vector 236 resulting in two planes 234, 238 that are at 90 degrees with each other at the conclusion of step 203.

A third vector 240 (n3) is defined via a cross product of the first plane 234 and the second plane 238, and a third plane 242 is drawn normal to the third vector 240 in a step 204.

After establishing the three planes 234, 238, 242, the relative orientation of the LiDAR system 20 and the vehicle body 12 is established by aligning the vectors 232, 236, 240 and using conventional calibration systems where the previously known physical planar targets are replaced with one or more of the three determined planes 234, 238, 242.

With continued regards to FIGS. 1 and 2, FIGS. 3-6 illustrate alternative physical structures from which the initial vector 232 and plane 234 of FIG. 2 can be constructed during step 202. In each example, the physical structure includes a feature defining a detectable line 230 and at least the line 230 and a ground plane 235 is used to derive the planes 234, 238, 242.

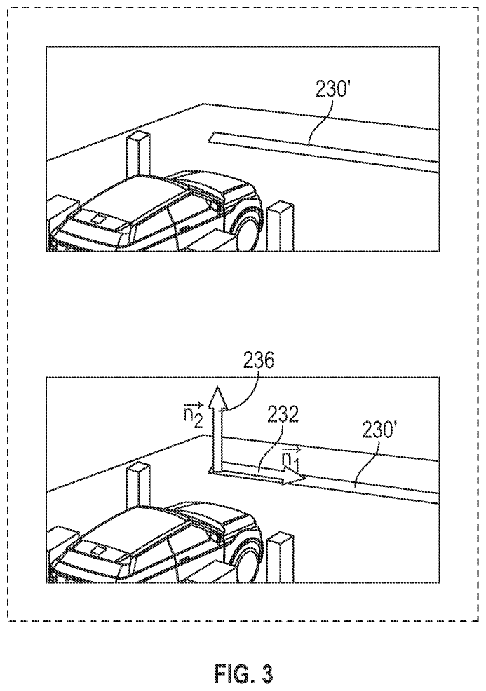

With reference to FIG. 3, positioning the vehicle 10 within the calibration blocks 210 includes aligning a line 30 at a front edge of the calibration blocks 210 such that the line 30 is at the front edge of the calibration blocks 210. The line 230 that is perpendicular to the front edge 30 of the vehicle 10 and of the calibration blocks 210 is replaced with a line 230′ parallel to the front edge of the calibration blocks 210. In similar examples, the line 230′ can be positioned at any known angle relative to the front edge of the calibration blocks. Using the horizontal line 230′, the first vector 232 and the second vector 236 are established in the same manner as the process of FIG. 2, with the horizontal line 230′ generating the second vector 236 as the initial vector 232 from which the planes 234, 238, 242 are derived.

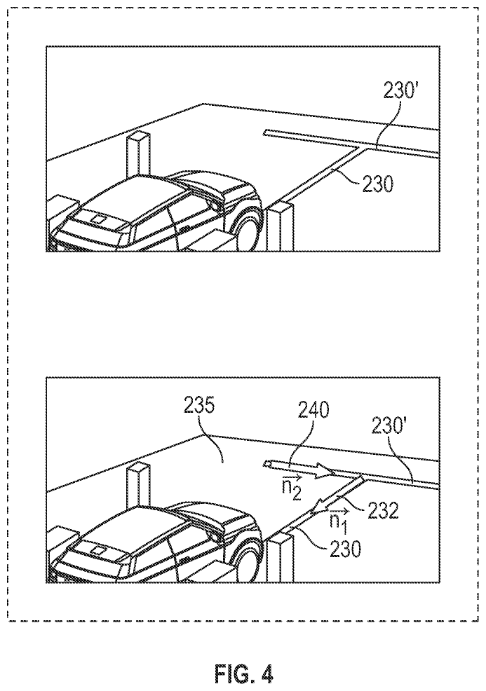

With reference to FIG. 4, the lines 230 (FIG. 2) and 230′ (FIG. 3) are both included, and the two vectors 232, 240 aligned with the ground plane 235 are directly determined from the lines 230, 230′ without requiring extrapolation, thereby allowing the controller 22 to define the three planes 234, 238, 242 faster than the baseline example of FIG. 2.

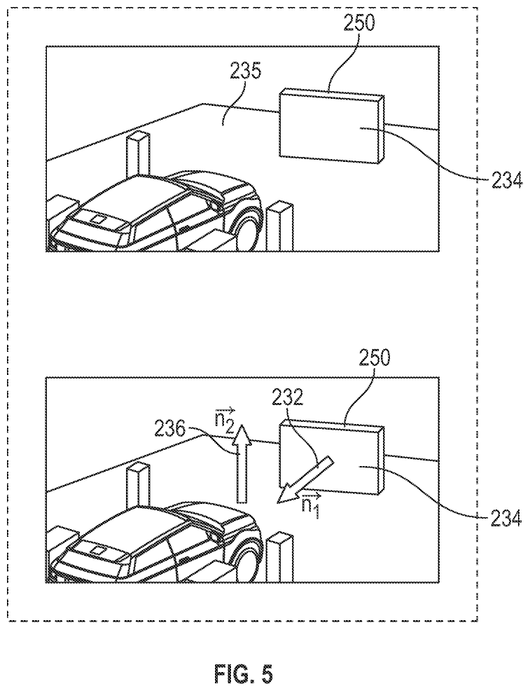

With reference to FIG. 5, the line 230′ of FIG. 3 is replaced using a planar structure 250, such as a wall. The planar structure 250 defines the first plane 234, and the first normal vector 232 is determined from the planar structure 250. The second normal vector 236 is determined from the ground plane 235, and the third vector 240 (illustrated in FIG. 2) is the cross product of the first vector 232 and the second vector 236.

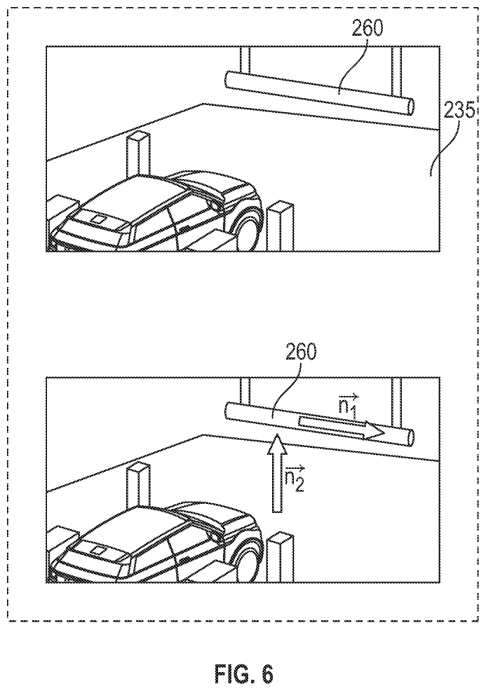

With reference to FIG. 6, a bar 260 is suspended over the ground plane 235. The bar 260 functions in the same manner as the line 230′ of FIGS. 3 and 4, however the bar 260 is suspended above the ground plane 235.

Utilization of the process and structure described herein provides a robust method for determining a relative position and orientation of the LiDAR system 20 and the vehicle body 12 by leveraging the controlled environment of the manufacturing alignment station including the use of a vehicle 10 centering device and precise localization of a retroreflective line 230. The process utilizes invisible calibration targets (planes 234, 238, 242) determined via prior knowledge of the controlled environment in the alignment station and an efficient LiDAR-to-Vehicle alignment algorithm which extracts calibration features abruptly from the calibration targets. Typically, the process only needs to detect one single line or physical structure and a ground plane 235 from the LiDAR raw data (point cloud 21), and then estimates normal vectors of three invisible targets. The proposed method then utilizes such information in optimizing the extrinsic parameters.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A process for calibrating a light detection and ranging (LiDAR) system comprising:
physically aligning a body on a calibration structure, wherein a LiDAR system is mounted on the body and centering the body using the calibration structure;
generating a LiDAR point cloud using the LiDAR system;
detecting a first linear structure and a ground plane using the LiDAR point cloud and determining a first vector aligned with the first linear structure;
identifying a first plane normal to the first vector;
identifying a second vector normal to the ground plane and in the first plane, and identifying a second plane normal to the second vector;
identifying a third vector at an intersection of the first plane and the second plane;
identifying a third plane normal to the third vector; and
calibrating an orientation of the LiDAR system relative to the body using the first plane, the second plane, the third plane, the first vector, the second vector, and the third vector.

2. The process of claim 1, wherein the first linear structure is a line disposed on the ground plane and extends from a front edge of the calibration structure.

3. The process of claim 1, wherein the first linear structure is a first line disposed in the ground plane within a range of the LiDAR system and wherein the line is approximately parallel to a front edge of the calibration structure.

4. The process of claim 3, wherein the first linear structure further comprises a second line disposed in the ground plane and extending perpendicular from the first line to a front edge of the calibration structure, and wherein the first vector is aligned with the second line.

5. The process of claim 1, wherein the first linear structure is a planar surface normal to the ground plane and wherein the first vector is normal to the planar surface, the second vector is normal to the ground plane, and the third vector is a cross product of the first vector and the second vector.

6. The process of claim 1, wherein the first linear structure is a linear bar suspended above, and parallel to, the ground plane.

7. The process of claim 1, wherein the first linear structure is contrasted with a surrounding environment.

8. The process of claim 7, wherein at least a portion of the first linear structure is one of a retroreflective paint and a retroreflective coating.

9. The process of claim 1, wherein the body is a vehicle body and wherein the process is performed using a vehicle controller within the vehicle body.

10. The process of claim 1, wherein centering the body using the calibration structure comprises physically moving the body using the calibration structure.

11. A light detection and ranging (LiDAR) calibration system comprising:
a body positioning system configured to identify an orientation of a body;
a first linear structure disposed in a known position relative to the body positioning system; and
a controller configured to identify a relative position and orientation of a LiDAR system mounted to a body within the body positioning system, relative to the body, by generating a LiDAR point cloud using the LiDAR system, detecting the first linear structure and a ground plane using the LiDAR point cloud and determining a first vector aligned with the first linear structure, identifying a first plane normal to the first vector, identifying a second vector normal to the ground plane and in the first plane, and identifying a second plane normal to the second vector, identifying a third vector at an intersection of the first plane and the second plane, identifying a third plane normal to the third vector, and calibrating an orientation of the LiDAR system relative to the body using the first plane, the second plane, the third plane, the first vector, the second vector, and the third vector.

12. The LiDAR calibration system of claim 11, wherein the first linear structure is a line disposed on the ground plane and extending from an edge of the body positioning system.

13. The LiDAR calibration system of claim 11, wherein the first linear structure is a first line disposed in the ground plane within a range of the LiDAR system and wherein the line is approximately parallel to a front edge of the body positioning system.

14. The LiDAR calibration system of claim 13, wherein the first linear structure further comprises a second line disposed in the ground plane and extending perpendicular from the first line to a front edge of the body positioning system, and wherein the first vector is aligned with the second line.

15. The LiDAR calibration system of claim 11, wherein the first linear structure is a planar surface normal to the ground plane and wherein the second vector is an edge of the planar surface and the third vector is a second edge of the planar surface.

16. The LiDAR calibration system of claim 11, wherein the first linear structure is a linear bar suspended above, and parallel to, the ground plane.

17. The LiDAR calibration system of claim 11, wherein the first linear structure is contrasted with a surrounding environment.

18. The LiDAR calibration system of claim 17, wherein at least a portion of the first linear structure is one of a retroreflective paint and a retroreflective coating.

19. The LiDAR calibration system of claim 11, wherein the body is a vehicle body.

20. A vehicle comprising:
a light detection and ranging (LiDAR) system; and
a vehicle controller in communication with the LiDAR system, the vehicle controller including a memory storing instructions to cause the controller to generate a LiDAR point cloud using the LiDAR system to detect a first linear structure and a ground plane using the LiDAR point cloud and to determine a first vector aligned with the first linear structure, to identify a first plane normal to the first vector, to identify a second vector normal to the ground plane and in the first plane, and to identify a second plane normal to the second vector, to identify a third vector at an intersection of the first plane and the second plane, to identify a third plane normal to the third vector, and to calibrate an orientation of the LiDAR system relative to the vehicle using the first plane, the second plane, the third plane, the first vector, the second vector, and the third vector.
